(19) United States
(12) Patent Application Publication
(10) Pub. No.: US 2011/0125534 A1
(43) Pub. Date: May 26, 2011

(54) SYSTEM AND METHOD FOR OPTIMIZING PARTICIPANT INTERACTION

(76) Inventors: Deborah L. DEAN, Cumming, GA (US); Ian Rushton, Marietta, GA (US)

(21) Appl. No.: 12/955,250

(22) Filed: Nov. 29, 2010

Related U.S. Application Data
(63) Continuation of application No. PCT/US2009/045694, filed on May 29, 2009.
(60) Provisional application No. 61/057,091, filed on May 29, 2008.

(51) Int. Cl. G06Q 50/00; G06Q 10/00

(52) U.S. Cl. 705/3; 705/2

(57) ABSTRACT

A system and method for optimizing contacts with participants in a disease management and wellness program. The system includes a computer-readable memory means for storing at least one participant profile, input means for receiving data regarding the effectiveness of a contact attempt with the plan participant, and processing means for modifying the participant profile based on the data regarding the effectiveness of a contact attempt with the plan participant, wherein the data regarding the effectiveness of the contact attempt comprises statistical aggregates. The method includes the steps of making an initial contact attempt with the plan participant via a first communications means; determining an effectiveness of the first communications means; and making a subsequent contact attempt with the plan participant via a second communications means, the second communications means selected based on the determination of effectiveness of the first communications means, wherein the effectiveness of the contact attempt is determined from statistical aggregates.

### CROSS-REFERENCE TO RELATED APPLICATIONS

This application is a continuation of International PCT Patent Application Serial No. PCT/US2009/045694, filed May 29, 2009, which claims the benefit of U.S. Provisional Patent Application Ser. No. 61/057,091, filed May 29, 2008, the entireties of which are hereby incorporated herein by reference for all purposes.

### BACKGROUND OF THE INVENTION

1. Field of the Invention

The present invention relates generally to the field of disease management and wellness programs, and more particularly to a system and method for contact management in the delivery of healthcare related services whereby interaction with plan participants is optimized.

2. Description of Background

Disease management and wellness programs benefit individuals by providing information and motivation to improve their health, assisting in monitoring conditions and managing illnesses, setting goals, and tracking progress. These programs also help employers and groups manage their healthcare and insurance costs, and improve productivity.

In order for such programs to be effective, however, regular contacts and information exchange between the participant and the provider are particularly advantageous. Various forms of contact have been utilized or proposed for disease management and wellness programs, including telephone, email, text messaging, device interaction and via the Internet.

As additional communication channels are developed, individuals generally receive more and more contact requests and have more and more sources of information competing for their attention. For example, surveys indicate that about 87% of people read email, 70% conduct Internet research, and 37% communicate using instant messaging. The extent of potential avenues for contact is further compounded by the use of home, cellular, and work telephone numbers, personal and business email accounts, instant messaging or social networking accounts with multiple systems, and the like.

At the same time, contacts are viewed by many recipients with increasing suspicion, and with the interposition of various “filters.” For example, actual desired contacts may be inadvertently blocked or ignored as unwanted “spam,” junk-mail or telemarketing calls. Publicized instances of identity theft or fraudulent transactions lead to increased wariness about incoming communications.

So paradoxically, even as the potential avenues for contact between plan participants and providers multiplies, it can be increasingly difficult to effectively maintain the desirable degree of contact and information exchange. Thus it can be seen that needs exist for improved systems and methods of managing contacts between disease management and wellness program providers and participants. It is to the provision of systems and methods meeting this and other needs that the present invention is primarily directed.

### SUMMARY OF THE INVENTION

Embodiments of the present invention provide a system and method for optimizing contacts in a management system between disease management and wellness program providers and participants. Briefly described, in architecture, one embodiment of the system, among others, can be implemented as follows. The system includes a computer-readable memory means for storing at least one participant profile; input means for receiving data regarding the effectiveness of a contact attempt with the plan participant; and processing means for modifying the participant profile based on the data regarding the effectiveness of a contact attempt with the plan participant, wherein the effectiveness of the contact attempt is determined from statistical aggregates.

In another aspect, the invention is a method of optimizing contacts with a plan participant. The method preferably includes the steps of making an initial contact attempt with the plan participant via a first communications means; determining an effectiveness of the first communications means; and making a subsequent contact attempt with the plan participant via a second communications means, the second communications means selected based on the determination of effectiveness of the first communications means, wherein the effectiveness of the contact attempt is determined from statistical aggregates.

Embodiments of the present invention can also be viewed as providing methods for optimizing contacts with a plan participant. In this regard, one embodiment of such a method, among others, can be broadly summarized by the following steps. The method operates by making an initial contact attempt with the plan participant via a first communications means; determining an effectiveness of the first communications means; and making a subsequent contact attempt with the plan participant via a second communications means, the second communications means selected based on the determination of effectiveness of the first communications means, wherein the effectiveness of the contact attempt is determined from statistical aggregates.

In another embodiment, the invention is computer program product for optimizing contacts with a plan participant. The computer program product preferably is embodied a tangible storage medium readable by an instruction processing system and storing instructions for execution by the instruction processing system for performing the method of optimizing contacts with a plan participant. The computer program product operates by making an initial contact attempt with the plan participant via a first communications means, and determining an effectiveness of the first communications means. The computer program product further operates by making a subsequent contact attempt with the plan participant via a second communications means, the second communications means selected based on the determination of effectiveness of the first communications means, wherein the effectiveness of the contact attempt is determined from statistical aggregates.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating an example of an environment computer system and the remote devices utilizing the optimized patient contact system according to an example form of the present invention.

FIG. 2 is a block diagram illustrating an example of a computer system utilizing the optimized patient contact system of the present invention.

FIG. 3 is a flowchart illustrating an example of the operation of the optimized patient contact system of the president tension on a host computer, as shown in FIGS. 1 and 2.

FIG. 4 is a flowchart illustrating an example of the operation of the configure process utilized by the optimized patient contact system of the present invention as shown in FIGS. 2 and 3.

FIG. 5 is a flowchart illustrating an example of the operation of the communication process utilized by the optimized patient contact system of the present invention as shown in FIGS. 2 and 3.

FIG. 6 is a flowchart illustrating an example of the operation of the optimization process utilized by the optimized patient contact system of the present invention as shown in FIGS. 2 and 3.

FIG. 7 shows the customization of contact with a participant via the optimized patient contact system and method of the present invention, based on pattern recognition and feedback acquired over a series of contacts.

The detailed description explains the preferred embodiments of the invention, together with advantages and features, by way of example with reference to the drawings.

### DETAILED DESCRIPTION OF THE INVENTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

In example embodiments, the present invention provides improved systems and methods of optimizing contacts between disease management and wellness program providers and participants. By providing customized communications targeted to the participant based on observed and/or predicted usage behaviors, marketing demographics and selected preferences, user participation may be increased, and results enhanced.

In various example forms of the invention, actual or attempted interactions or exchanges of information between the participant and the provider (referred to herein as “contacts” or “touches”) are enabled via any existing or future-developed communication means, including without limitation, paper, phone (i.e. voice), email, secure email, fax, text messaging, and/or Internet chat; and the manner and means of contact are optimized based on aggregate and/or individual statistical data or profiles.

Data is collected regarding the success and effectiveness of contact achieved via the various manners and means of contact, and is compiled and utilized on an individual and/or collective basis to further enhance the success and effectiveness of future contacts with participants. Subsequent contacts are thereafter implemented and optimized based on what has been learned from prior contacts with the individual participant, and/or based on statistical modeling developed from contacts with one or more other program participants.

In example form, the system and method of the present invention improves enrollment rates and effectiveness of disease management and wellness programs by learning the best means (e.g., phone contact, email, text-messaging, Internet chat, web-delivery, Outlook or other calendar invitation, and/or other existing or yet to be developed form of communication) and/or best manner (e.g., time of day, day of week, short vs. long message, detailed or summary content, inquiry or demand, male or female voice, text or video, content or attachment format, number of attempts, etc.) of contacting and engaging a particular participant and/or type of participant, and optimizing future contacts with that participant and/or with other participants having one or more similar characteristics, based on pattern recognition and feedback acquired over one or more contacts and/or attempted contacts.

The system and method of the present invention optimizes the means and manner of contact in terms of both initiating contact with a participant to begin involvement in the program, and in terms of maintaining contact to keep the participant involved in the program and continued and ongoing exchange of data between the participant and the provider. The contacts or “touches” between the participant and the provider enabled by the system and method of the present invention may take the form of both outreaches for delivering information to the participant (“push” contacts), and for gathering or collecting information from the participant (“pull” contacts). The plan participant may be the individual receiving care, the caregiver, the insurer, or any other party involved in a disease management and wellness programs. The information exchanged in a contact may include treatment information, medical conditions or measurements (weight, heart-rate, blood-pressure, blood-sugar, etc.), compliance confirmation, exercise plans, medication scheduling or reminders, or other types of information.

With reference now to the drawing figures, wherein like reference numbers represent corresponding parts throughout the several views,

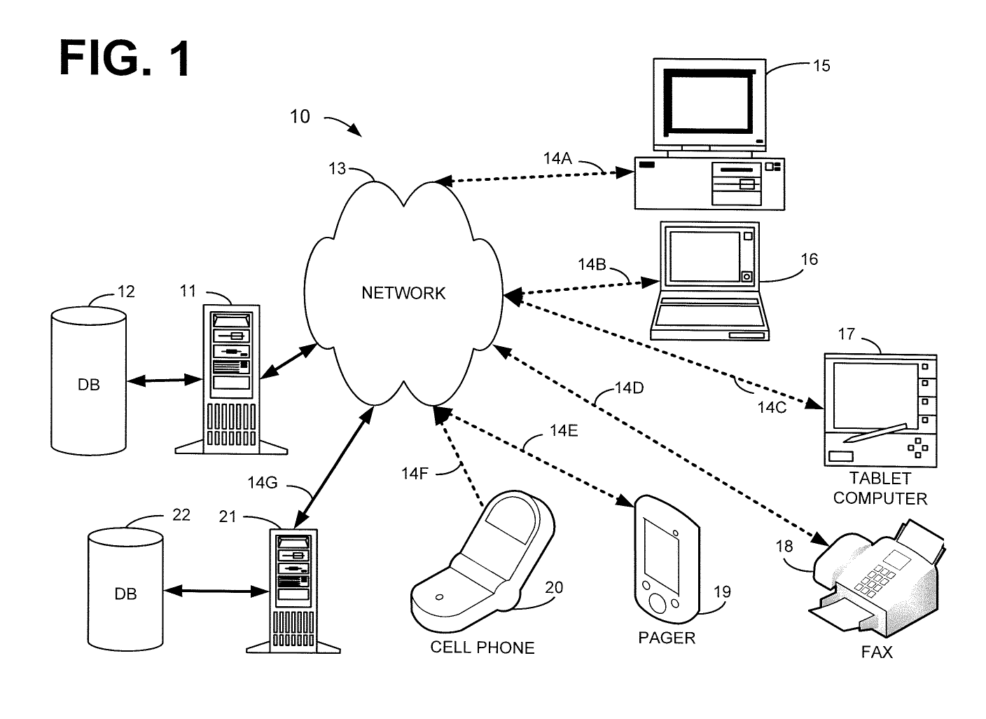

Referring now to the drawings, in which like numerals illustrate like elements throughout the several views. FIGS. 1-7 show by way of various examples the system and method for optimizing contacts (i.e. touches) between a plan participant and the provider of a disease management and wellness program, according to the present invention. FIG. 1 illustrates an example of the basic components of a system 10 using the optimized patient contact system used in connection with the preferred embodiment of the present invention. The system 10 includes a server 11 and the remote devices 15, 16, 17, 18, 19, 20 or 21 that utilize the optimized patient contact system of the present invention.

Each remote device 15-21 can have applications and can have a local database, such as database 22. Server 11 contains applications, and a database 12 that can be accessed by remote device 15-20 via connections 14(A-G), respectively, over network 13. The server 11 runs administrative software for a computer network and controls access to itself and database 12. The remote device 15-21 may access the database 12 over a network 13, such as but not limited to: the Internet, a local area network (LAN), a wide area network (WAN), via a telephone line using a modem (POTS), Bluetooth, WiFi, cellular, optical, satellite, RF, Ethernet, magnetic induction, coax, RS-485, the like or other like networks. The server 11 may also be connected to the local area network (LAN) within an organization.

The remote device 15-21 may each be located at remote sites. Remote device 15-21 include but are not limited to, PCs, workstations, laptops, handheld computer, pocket PCs, PDAs, pagers, WAP devices, non-WAP devices, cell phones, palm devices, printing devices, fax machine and the like.

Thus, when a user at one of the remote devices 15-21 desires to access the patient information from the database 12 at the server 11, the remote device 15-21 communicates over the network 13, to access the server 11 and database 12.

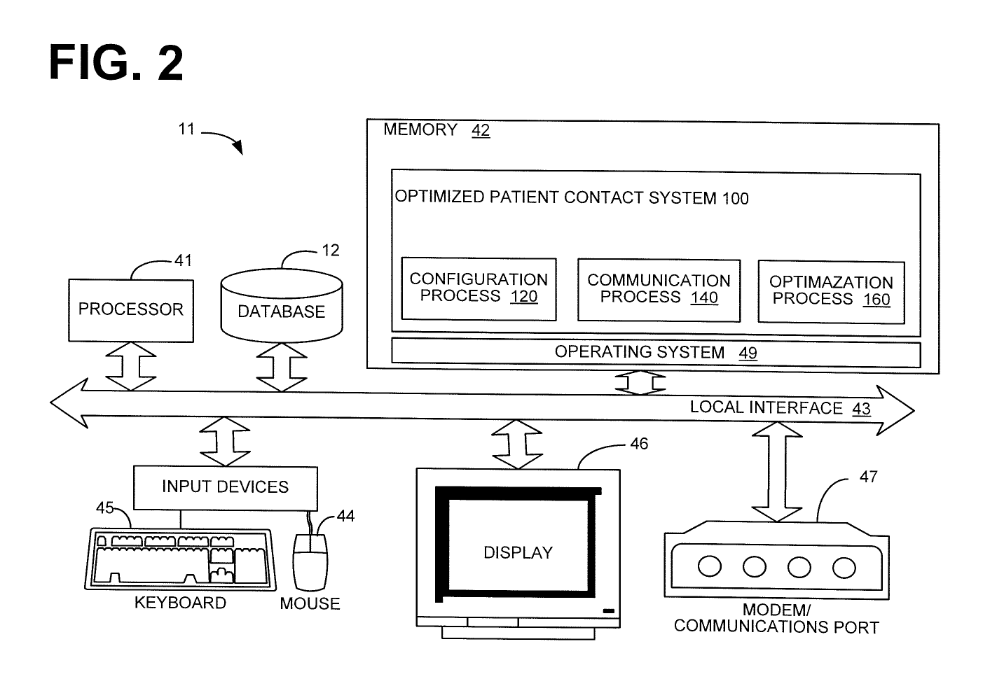

Illustrated in FIG. 2 is a block diagram demonstrating an example of server 11, as shown in FIG. 1, utilizing the optimized patient contact system 100 of the present invention. Server 11 includes, but is not limited to, PCs, workstations, laptops, PDAs, palm devices and the like. The processing components of the remote devices 15-21 are similar to that of the description for the server 11 (FIG. 2).

Generally, in terms of hardware architecture, as shown in FIG. 2, the server 11 include a processor 41, memory 42, and one or more input and/or output (I/O) devices (or peripherals) that are communicatively coupled via a local interface 43. The local interface 43 can be, for example but not limited to, one or more buses or other wired or wireless connections, as is known in the art. The local interface 43 may have additional elements, which are omitted for simplicity, such as controllers, buffers (caches), drivers, repeaters, and receivers, to enable communications. Further, the local interface 43 may include address, control, and/or data connections to enable appropriate communications among the aforementioned components.

The processor 41 is a hardware device for executing software that can be stored in memory 42. The processor 41 can be virtually any custom made or commercially available processor, a central processing unit (CPU), data signal processor (DSP) or an auxiliary processor among several processors associated with the server 11, and a semiconductor based microprocessor (in the form of a microchip) or a macroprocessor. Examples of suitable commercially available microprocessors are as follows: an 80x86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 42 can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 42 may incorporate electronic, magnetic, optical, and/or other types of storage media. Note that the memory 42 can have a distributed architecture, where various components are situated remote from one another, but can be accessed by the processor 41.

The software in memory 42 may include one or more separate programs, each of which comprises an ordered listing of executable instructions for implementing logical functions. In the example illustrated in FIG. 2, the software in the memory 42 includes a suitable operating system (O/S) 49 and the optimized patient contact system 100 of the present invention. As illustrated, the optimized patient contact system 100 of the present invention comprises numerous functional components including, but not limited to, the configuration process 120, communication process 140 and optimization process 160.

A non-exhaustive list of examples of suitable commercially available operating systems 49 is as follows (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., Symbian OS available from Symbian, Inc., PalmOS available from Palm Computing, Inc., and Windows CE available from Microsoft Corporation).

The operating system 49 essentially controls the execution of other computer programs, such as the optimized patient contact system 100, and provides scheduling, input-output control, file and data management, memory management, and communication control and related services. However, it is contemplated by the inventors that the optimized patient contact system 100 of the present invention is applicable on all other commercially available operating systems.

The optimized patient contact system 100 may be a source program, executable program (object code), script, or any other entity comprising a set of instructions to be performed. When a source program, then the program is usually translated via a compiler, assembler, interpreter, or the like, which may or may not be included within the memory 42, so as to operate properly in connection with the O/S 49. Furthermore, the optimized patient contact system 100 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices may include input devices, for example but not limited to, a mouse 44, keyboard 45, scanner (not shown), microphone (not shown), etc. Furthermore, the I/O devices may also include output devices, for example but not limited to, a printer (not shown), display 46, etc. Finally, the I/O devices may further include devices that communicate both inputs and outputs, for instance but not limited to, a NIC or modulator/demodulator 47 (for accessing remote devices, other files, devices, systems, or a network), a radio frequency (RF) or other transceiver (not shown), a telephonic interface (not shown), a bridge (not shown), a router (not shown), etc.

If the server 11 is a PC, workstation, intelligent device or the like, the software in the memory 42 may further include a basic input output system (BIOS) (omitted for simplicity). The BIOS is a set of essential software routines that initialize and test hardware at startup, start the O/S 49, and support the transfer of data among the hardware devices. The BIOS is stored in some type of read-only-memory, such as ROM, PROM, EPROM, EEPROM or the like, so that the BIOS can be executed when the server 11 is activated.

When the server 11 are in operation, the processor 41 is configured to execute software stored within the memory 42, to communicate data to and from the memory 42, and to generally control operations of the server 11 are pursuant to the software. The optimized patient contact system 100 and the O/S 49 are read, in whole or in part, by the processor 41, perhaps buffered within the processor 41, and then executed.

When the optimized patient contact system 100 is implemented in software, as is shown in FIG. 2, it should be noted that the optimized patient contact system 100 can be stored on virtually any computer readable medium for use by or in connection with any computer related system or method. In the context of this document, a computer readable medium is an electronic, magnetic, optical, or other physical device or means that can contain or store a computer program for use by or in connection with a computer related system or method.

The optimized patient contact system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD RAN) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In an alternative embodiment, where the optimized patient contact system 100 is implemented in hardware, the optimized patient contact system 100 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

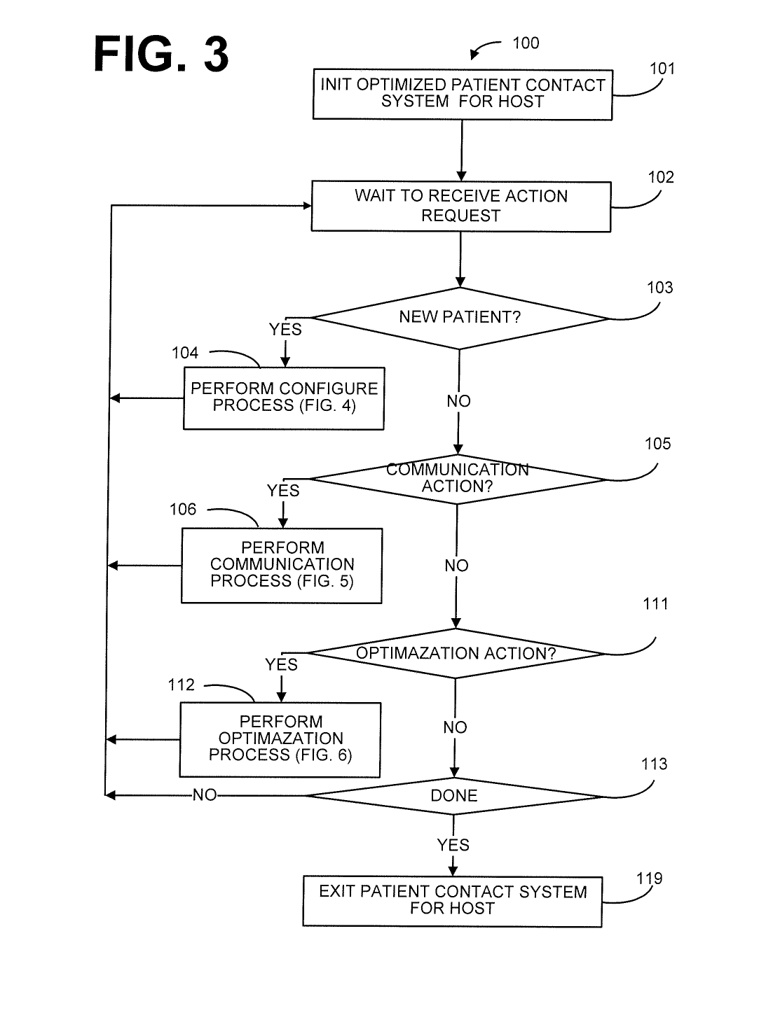

FIG. 3 is a flowchart illustrating an example of the operation of the optimized patient contact system 100 of the present invention on a host computer, as shown in FIGS. 1 and 2. In example forms, the optimized patient contact system 100 is a server-based software system comprising computer-executable instructions for receiving, storing, processing and delivering electronic signals and/or data. The invention includes the method and system described, as well as software for implementing the method and system, and articles of manufacture comprising computer-readable media having the software resident thereon.

First at step 101, the optimized patient contact system 100 is initialized. This initialization includes a startup routines and processes embedded in the BIOS of the server 11. The initialization also includes the establishment of data values for particular data structures utilized in the server 11.

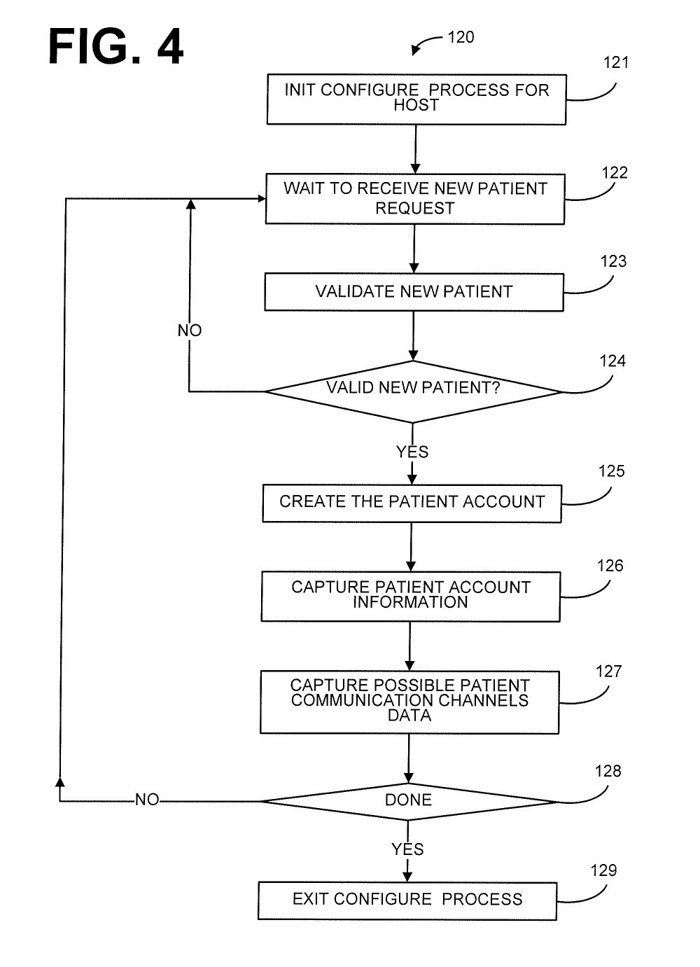

At step 102, the optimized patient contact system 100 waits for an action request. Upon receiving an action request, the optimized patient contact system 100 determines if the action request is to add a new patient at step 103. If it is determined at step 103 that the action requested is not to add a new patient, then the optimized patient contact system 100 proceeds to step 105. However, if it is determined at step 103 that the action received is the request to add a new patient, then the optimized patient contact system 100 performs the configuration process at step 104. The configuration process is herein defined in further detail with regard to FIG. 4. The optimized patient contact system 100 then returns to repeat step 102.

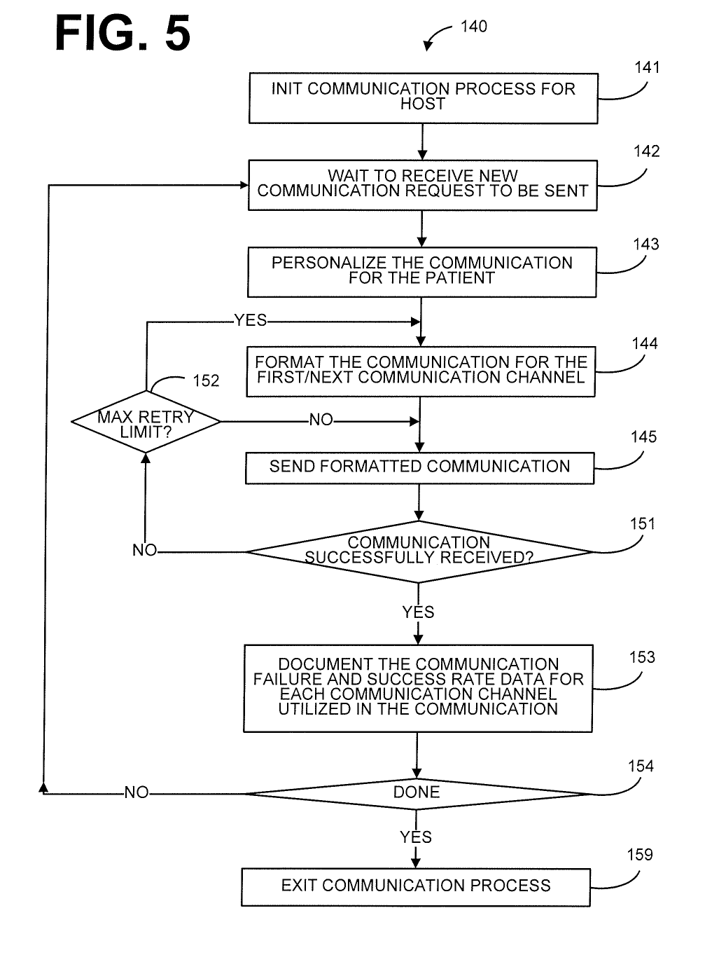

At step 105, the optimized patient contact system 100 determines if the action requested is a communication action. If it is determined at step 105 that the action requested is not a communication action, then the optimized patient contact system 100 proceeds to step 111. However, if it is determined at step 105 that the action requested is a communication action, then the communication process is performed at step 106. The communication process is herein defined in further detail with regard to FIG. 5. After performing the communication process, the optimized patient contact system 100 then returns to repeat step 102.

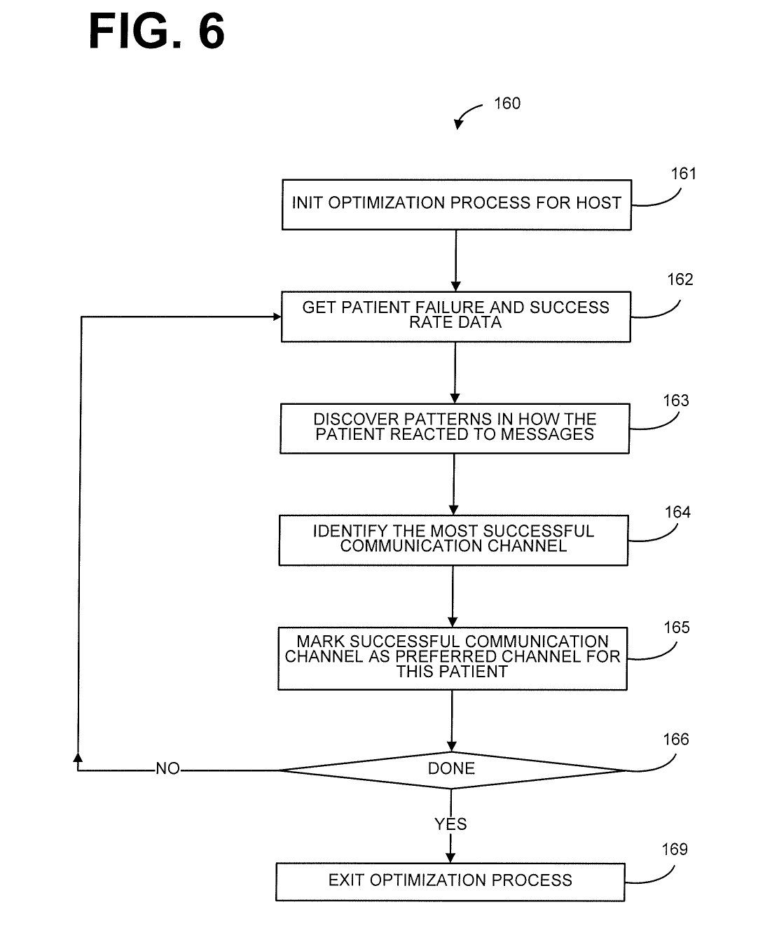

At step 111, the optimized patient contact system 100 determines if the action is an optimization action. If it is determined at step 111 that the requested action is not an optimization action, then the optimized patient contact system 100 proceeds to step 113. However, if it is determined in step 111 that the requested action is an optimization action, then the optimized patient contact system 100 proceeds to step 112 to perform the optimization process. The optimization process is herein defined in further detail with regard to FIG. 6. After performing the optimization process, the optimized patient contact system 100 then returns to repeat step 102.

At step 113, the optimized patient contact system 100 determines that there is more contact patient data to be processed. If it is determined at step 113 that there is more contact patient data to be processed, then the optimized patient contact system 100 returns to repeat steps 102-113. However, if it is determined at step 113 that there are no more contact patient data to be processed, then the optimized patient contact system 100 exits at step 119.

FIG. 4 is a flowchart illustrating an example of the operation of the configure process 120 utilized by the optimized patient contact system 100 of the present invention as shown in FIGS. 2 and 3. The configure process 120 is used to create a new patient profile or modify a current patient profile by either a clinician, fulfillment specialist, Nurse or the like.

First at step 121, the configure process 120 is initialized. This initialization includes a startup routines and processes embedded in the BIOS of the server 11. The initialization also includes the establishment of data values for particular data structures utilized in the server 11.

At step 122, the configure process 120 waits to receive a request to add a new patient or to modify a current patient's account information. Once receiving such request at step 122, then the configure process 120 validates the patient at step 123. If it is a new patient, this step make sure that the patient is not currently in the system, and for a modification of a current patient, then this step is to make sure that that patient is in the system. At step 124, the validation is performed. If it is determined that the patient is a valid new patient or current patient, then the configure process 120 proceeds to step 125. However, if it is determined at step 124 that the new patient is not valid or that the current patient information to be modified is not listed, then the configure process 120 returns to repeat step 122.

At step 125, the configure process 120 then enables the clinician, fulfillment specialist, nurse or the like to create a patient account. If this requested action is to modify a current patient, then the system pulls up the information for the patient current patient to be modified. At step 126, the configure process 120 captures the new patient account information or enables a current patient account information to be modified.

At step 127, the interaction with the patient communication channels is performed. If it is a new patient, then the configure process 120 captures possible patient communication channels and data related to those channels. For instance if the patient which is to be communicated with by e-mail, then the system needs the patient's e-mail address input. However if the patient wishes to be communicated with the phone or SMS, then the system needs to document the patient's telephone number. All the varieties of different communication channels that can be utilized need to be captured or updated at this point. A participant profile is developed, and is optionally initially based on a predicted profile based on demographic statistics or other data. For example, it may be determined that participants within a certain age group or geographic region are more likely to respond to contacts delivered via Short Message Service (SMS) text-messaging, rather than by telephone.

At step 128, the configure process 120 determines if there is more patient configuration to be performed. If it is determined in step 128 that there is more patient data to be configured, then the configure process 120 returns to repeat steps 122-128. However, if it is determined in step 128 that there is no more patient data to configure, then the configure process 120 exits at step 129.

FIG. 5 is a flowchart illustrating an example of the operation of the communication process 140 utilized by the optimized patient contact system 100 of the present invention as shown in FIGS. 2 and 3. The communication process 140 utilizes a centralized repository which drives the reuse of content and consistency of messaging. Communication rules include sequencing and coordination of communication channels as well as lifestyle segmentation data to aid in the determination of communication channels to be utilized. The preferred channels of communication include, but are not limited to paper (i.e. snail mail), e-mail, text messaging (i.e. SMS), phone calls, online chats and the like. The communication intent is patient enrollment information, current health information, verify vaccinations, education of the patient, assessing the health knowledge of the patient, and the like.

First at step 141, the communication process 140 is initialized. This initialization includes a startup routines and processes embedded in the BIOS of the server 11. The initialization also includes the establishment of data values for particular data structures utilized in the server 11.

At step 142, the communication process 140 waits to receive a new communication request to be sent. In one illustrative example, a clinician accesses the system through a Clinical Operating System (COS) to initiate a contact.

After receiving a request to send a communication, then the communication is personalized for the individual patient at step 143. It is contemplated that a clinician, fulfillment specialist, nurse or the like, sends a request to a patient either providing information, requesting an action or information in return. The communication process 140 then will build the document and format for delivery via the appropriate communication channel. The information to properly build and format the message is retrieved from a CMS based on rules and configuration. The message is assembled and personalized for each patient. The personalization information is retrieved from data in the patient's account. This data was captured in the configuration process 120 (FIG. 4).

At step 144, the communication is formatted for the first communication channel. This formatting is necessary because of the data being sent. If the data is sent by e-mail, voice message or snail mail, then the text can be formatted for those mediums. However, the amount of information sent via snail mail is vastly different than that that would be sent in an SMS message. Most SMS messages have a limited length of characters that could be sent at any one time, so either the words are abbreviated or the message is broken up into multiple packets.

At step 145, the formatted message is then sent on a communication channel for which the message was formatted. An initial outreach contact attempt is made to the participant via one or more communication means, optionally selected based on the predicted profile, known participant data, and/or other selection criteria. Optionally, two or more initial outreach contact attempts are directed to the participant via different communication means and/or in different manners, and/or with differing content, to see which variation is most effective. In example embodiments, the content of each contact is personalized by the Content Management System (CMS), based on the participant profile or other criteria. For example, the initial contact may request the participant to provide enrollment information and/or one or more Clinical Performance Indicators (CPI) such as known conditions, symptoms, allergies, treatments, etc., to take certain actions, and/or simply confirm receipt of the contact.

At step 151, the communication process 140 then waits to receive feedback indicating that the medication/treatment was successfully received. If the initial outreach contact attempt is unsuccessful, one or more subsequent contact attempts are made, optionally using different communication means and/or in different manners, and/or with differing content. If and when a contact attempt is successful (e.g., a response or receipt acknowledgement is received, and/or the response quality is acceptable), the means, manner and content of the successful contact is noted, and one or more response parameters are determined and recorded, for example: the time delay from contact attempt to response, the number of contact attempts required to prompt a response, and the quality of the response, etc.

If it is determined at step 151 that the communication was successfully received, then the communication process 140 then proceeds to step 153. However, if it is determined at step 151 that the communication was not received within a maximum timeout period, then the communication process 140 determines if this communication channel method has reached its maximum retry limit at step 152. If it is determined in step 152 that the maximum retry limit has not been reached, then the communication process 140 increments the retry counter and returns to step 145 to send the formatted message on the current communication channel. However, if it is determined in step 152 that maximum retry limit has been reached for the current communication channel, then the communication process 140 then returns to step 144 and format the message for the next communication channel in the patient's communication channels data. This reformatted message is then resent on the next communication channel. The communication process 140 then returns repeat step 151.

At step 153, the communication process 140 then documents the communication failure and success rate data for each communication channel utilized in the communication of the message. The participant profile is updated based on both successful and unsuccessful contact attempts. For example, a negative indicator may be recorded for unsuccessful contacts and a positive indicator for successful contacts. Optionally, the indicators can be weighted by one or more factors, including the quality or degree of responsiveness. For example, the determined effectiveness of various contact modalities (including the contact means, manner of contact, and/or contact content) can be designated with a scaled identifier designating a degree of success within a specified range (e.g., 1/5, 0/−10, etc.), or with a discrete identifier (0 or 1, success or failure). This feedback loop allows for effective this measurement and could allow for subgroup experimentation is to improve. This also allows the users to discover patterns of how the patients react to messages.

At step 154, the communication process 140 determines if there is more patient communications to be performed. If it is determined in step 154 that there are more patient communications to be performed, then the communication process 140 returns to repeat steps 142-154. However, if it is determined in step 154 that there is no more patient data to communicate, then the communication process 140 exits at step 159.

FIG. 6 is a flowchart illustrating an example of the operation of the optimization process 160 utilized by the optimized patient contact system 100 of the present invention as shown in FIGS. 2 and 3. The optimization process 160 analyzes the contacts and responses as the participant profile is updated over time, and one or more patterns and preferences are sought to be recognized. For example, a particular profile may indicate that a participant responds more quickly to text message contacts, but with a low quality responsiveness in terms of the information reported; whereas that same person responds more slowly to telephone contacts, but with a higher quality of responsiveness. In such circumstances, the system may determine that “push” contacts that only require the participant to acknowledge receipt of information are better sent by text message, but that “pull” contacts requiring the participant to provide data in response are better done by phone. Likewise, the system and method of the invention may determine that a particular participant is willing to respond by email with information regarding scheduling a follow-up session, but is not willing to respond by email with information they consider more confidential such as medical conditions.

Subsequent contacts to the participants are made using one or more means and/or manners selected based on the participant profile. The selection may be based on the aggregate profile, or may be weighted based on temporal trends recognized by the system. For example, if a particular participant is on vacation, the system may recognize a temporary trend for that participant to better respond to contact attempts via their cellular telephone rather than via their work email, even though in the aggregate that participant responds better to email contacts. The optimized patient contact system 100 can distinguish between differing types of contacts and determine an optimal contact modality for each type of contact, which may be the same or different depending on the type of contact required. By constantly updating and refining the participant profile based on successive contacts and attempted contacts, the optimized patient contact system 100 learns the means and manner most likely to result in a successful contact, and optimizes subsequent contacts based on the learned data.

First at step 161, the optimization process 160 is initialized. This initialization includes a startup routines and processes embedded in the BIOS of the server 11. The initialization also includes the establishment of data values for particular data structures utilized in the server 11.

At step 162, the optimization process 160 gets the first patients failure and success rate data. The failure and success rate data is then processed to discover patterns and how the patients reacted to the messages at step 163. At step 164, the optimization process 160 identifies the most successful communication channel. At step 165, the optimization process 160 marks the most successful communication channel as a preferred channel for this patient and the patient's communication channels data stored on a database 12.

In addition to updating an individual participant's profile based on the learned data from contacts and attempted contacts with that particular participant, the optimization process 160 optionally also compiles statistical data correlating the effectiveness of various contact modalities with one or more participant characteristics. For example, statistical aggregates can be determined based on participant characteristics such as age, gender, geographic location, education level, job title, income level, marital status, medical conditions, etc. These statistical aggregates can be used to predict which contact modality is most likely to be effective with a new program participant in the initial outreach contact attempt and/or in subsequent contact attempts. Individual participant profiles can optionally also be adjusted or weighted based on the statistical aggregates.

At step 166, the optimization process 160 determines if there is more patient failure and success rate data to be processed. If it is determined at step 166 that there is more patient data to be processed, then the optimization process 160 returns to repeat steps 162-166. Otherwise, the optimization process 160 then exits at step 169

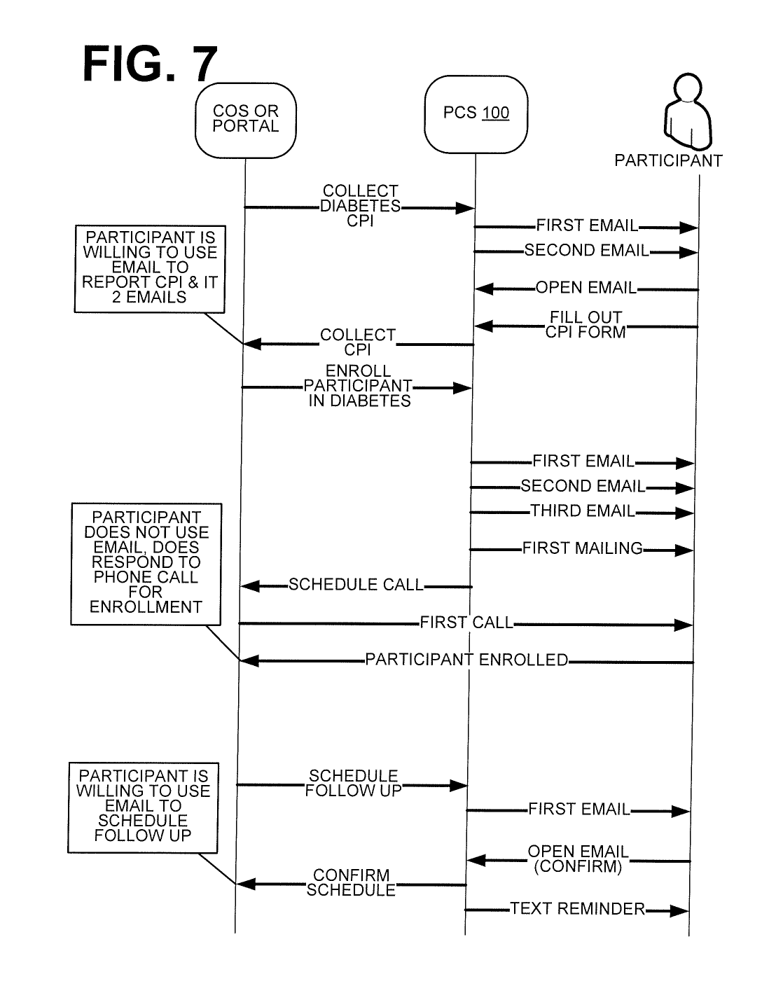

FIG. 7 shows examples of contact with a participant (i.e. patient) via the optimized patient contact system 100 and method of the present invention, based on pattern recognition and feedback acquired over a series of contacts.

For example, first the clinician, fulfillment specialist, nurse or the like, sends a request to the optimized patient contact system to collect information from a patient. In the illustrated example, the patient information is with regard to diabetes. The optimized patient contact system 100 then sends a first e-mail to a participant. After waiting an appropriate timeout period, the optimized patient contact system 100 sends a second e-mail to the participant. Prior to the timeout period expiring for the second e-mail, the participant opens the e-mail which causes a notification to be sent back to the optimized patient contact system 100. Then prior to a timeout, the participant fills out the diabetes information requested and sends that to the optimized patient contact system 100. The optimized patient contact system 100 then forward that collected information back to the clinician, fulfillment specialist, nurse or the like. This indicates that the participant is willing to use e-mail to report information and it took two e-mails to acquire this information.

In the next attempt to establish the communication with a participant, a clinician, fulfillment specialist, nurse or the like, then sends an enrollment message to the participant. The optimized patient contact system 100 then processes the enrollment message, formats it for e-mail delivery and sends the message via e-mail to the participant. After waiting a period of predetermined period of time a timeout occurs and a second e-mail is sent to the participant. After another predetermined period of time a timeout occurs, so a third e-mail is sent. At this time the optimized patient contact system 100 determines that this participant is not utilizing e-mail and then formats the communication in a first regular mail i.e. snail mail. After waiting a second predetermined time period, the optimized patient contact system 100 sends a message to the clinician, fulfillment specialist, nurse or the like to schedule a phone call. This phone call is then placed to the participant at the scheduled time. The scheduled time is set when the participant is enrolled in the plan. At this time, the optimized patient contact system 100 determines that the patient does not use e-mail, but instead responses to phone calls for enrollment.

In a third attempt to establish a communication with a participant, the clinician, fulfillment specialist, nurse or the like, sends a follow-up message to the optimized patient contact system 100. The optimized patient contact system 100 then formats and personalizes the communication in a first e-mail to the participant. When the e-mail is opened, a confirmation is returned to the optimized patient communications system 100. The optimized patient contact system 100 then sends a message to the clinician, fulfillment specialist, nurse or the like, to confirm a scheduled follow-up. The optimized patient contact system 100 then determines that this participant is willing to use e-mail to schedule follow-up sessions. Lastly, the optimized patient contact system 100 sends a reminder text to the participant to remind them of the scheduled follow-up at the appropriate time.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It should be emphasized that the above-described embodiments of the present invention, particularly, any “preferred” embodiments, are merely possible examples of implementations, merely set forth for a clear understanding of the principles of the invention. Many variations or modifications, additions and deletions may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for optimizing the mode of contact with a medical plan participant, on an instruction processing system, comprising a tangible storage medium readable by the instruction processing system and storing instructions for execution by the instruction processing system, said system comprising:
a computer-readable memory means for storing at least one participant profile;
input means for receiving data regarding the effectiveness of a contact attempt with the medical plan participant; and
processing means for modifying the at least one participant profile based on the data regarding the effectiveness of the contact attempt with the medical plan participant, wherein the data regarding the effectiveness of the contact attempt comprises statistical aggregates.

2. The system of claim 1, wherein the contact attempt utilizes a first communication channel, and wherein a second contact attempt utilizes a SMS message if the participant does not respond to a predetermined number of contact attempts using the first communication channel.

3. The system of claim 1, wherein the contact attempt utilizes a first communication channel, and wherein a second contact attempt utilizes a voice message if the participant does not respond to a predetermined number of contact attempts using the first communication channel.

4. The system of claim 1, further comprising:
a plurality of communication channels for the contact attempt, wherein the plurality of communication channels is selected from the group consisting of email, fax, text messaging, paper, phone, web-delivery, Outlook and Internet chat.

5. The system of claim 1, wherein the statistical aggregates further comprises:
a time delay from the contact attempt to a response for the medical plan participant; and
a number of the contact attempts required to prompt the response from the medical plan participant.

6. The system of claim 1, wherein the statistical aggregates further comprises:
a time delay from the contact attempt to a response for a plurality of medical plan participants with at least one similar characteristic; and
a number of the contact attempts required to prompt the response from the plurality of medical plan participants with the at least one similar characteristic.

7. The system of claim 1, wherein the statistical aggregates further comprises participant characteristics wherein the participant characteristics is selected from the group consisting of age, gender, geographic location, education level, job title, income level, marital status, medical conditions.

8. A method of optimizing contacts with a plan participant embodied in a computer program product for execution on an instruction processing system, comprising a tangible storage medium readable by the instruction processing system and storing instructions for execution by the instruction processing system for performing the method comprising:
making an initial contact attempt with the plan participant via a first communications means;
determining an effectiveness of the first communications means; and
making a subsequent contact attempt with the plan participant via a second communications means, the second communications means selected based on the determination of effectiveness of the first communications means, wherein the effectiveness of the contact attempt is determined from statistical aggregates.

9. The method of claim 8, wherein the contact attempt utilizes a first communication channel, and wherein a second contact attempt utilizes a SMS message if the participant does not respond to a predetermined number of contact attempts using the first communication channel.

10. The method of claim 8, wherein the contact attempt utilizes a first communication channel, and wherein a second contact attempt utilizes a voice message if the participant does not respond to a predetermined number of contact attempts using the first communication channel.

11. The method of claim 8, wherein the statistical aggregates further comprises:
a time delay from the contact attempt to a response for the medical plan participant; and
a number of the contact attempts required to prompt the response from the medical plan participant.

12. The method of claim 8, wherein the statistical aggregates further comprises:
a time delay from the contact attempt to a response for a plurality of medical plan participants with at least one similar characteristic; and
a number of the contact attempts required to prompt the response from the plurality of medical plan participants with the at least one similar characteristic.

13. The method of claim 8, wherein the statistical aggregates further comprises participant characteristics wherein the participant characteristics is selected from the group consisting of age, gender, geographic location, education level, job title, income level, marital status, medical conditions.

14. A computer program product for optimizing contacts with a plan participant embodied in a tangible storage medium readable by an instruction processing system and storing instructions for execution by the instruction processing system for performing a method comprising:
making an initial contact attempt with the plan participant via a first communications means;
determining an effectiveness of the first communications means; and
making a subsequent contact attempt with the plan participant via a second communications means, the second communications means selected based on the determination of effectiveness of the first communications means, wherein the effectiveness of the contact attempt is determined from statistical aggregates.

15. The computer program product of claim 14, wherein the contact attempt utilizes a first communication channel, and wherein a second contact attempt utilizes a SMS message if the participant does not respond to a predetermined number of contact attempts using the first communication channel.

16. The computer program product of claim 14, wherein the contact attempt utilizes a first communication channel, and wherein a second contact attempt utilizes a voice message if the participant does not respond to a predetermined number of contact attempts using the first communication channel.

17. The computer program product of claim 14, wherein the statistical aggregates further comprises:
a time delay from the contact attempt to a response for the medical plan participant; and
a number of the contact attempts required to prompt the response from the medical plan participant.

18. The computer program product of claim 14, wherein the statistical aggregates further comprises:
a time delay from the contact attempt to a response for a plurality of medical plan participants with at least one similar characteristic; and
a number of the contact attempts required to prompt the response from the plurality of medical plan participants with the at least one similar characteristic.

19. The computer program product of claim 14, wherein the statistical aggregates further comprises participant characteristics wherein the participant characteristics is selected from the group consisting of age, gender, geographic location, education level, job title, income level, marital status, medical conditions.
